(19) United States
(12) Patent Application Publication
(10) Pub. No.: US 2010/0293850 A1
(43) Pub. Date: Nov. 25, 2010

(54) System and Method for Propagation of Plant Cuttings, Seeds, and Tissue Culture Plantlets

(76) Inventor: Paul Robert Fisher, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/742,742

(22) PCT Filed: Dec. 23, 2008
(86) PCT No.: PCT/US08/88166

§ 371 Date: Aug. 3, 2010

Related U.S. Application Data
(60) Provisional application No. 61/010,414, filed on Jan. 7, 2008.
(60) Provisional application No. 61/087,028, filed on Aug. 7, 2008.

(51) Int. Cl. A01G 9/10; A47B 96/00; A01G 9/02

(52) U.S. Cl. 47/66.7; 211/71.01; 47/73

(57) ABSTRACT

Systems and devices are provided for the handling and transport of plants, cuttings, tissue-cultured plantlets, and/or seeds. Said system comprising a prop-string having one or more prop-tubes affixed thereto and in alignment with the cells of a transplant liner tray. Plant, cuttings, tissue-cultured plantlets, or seeds are positioned within the prop-tubes for transport. Upon transplanting, the prop-tube with the plant, cutting, tissue-cultured plantlet, or seeds therein are positioned within transplant liner tray cells. The prop-tubes will not interfere with rooting or growth of the plant and can be biodegradable or an inert material. Said system facilitates the simultaneous transplant of multiple plants, cuttings, tissue-cultured plantlets, or seeds.

### CROSS-REFERENCE TO A RELATED APPLICATION

This application claims the benefit of U.S. provisional applications Ser. No. 61/010,414, filed Jan. 7, 2008 and Ser. No. 61/087,028, filed Aug. 7, 2008, which are incorporated herein by reference in their entirety.

### BACKGROUND OF INVENTION

The USDA National Agricultural Statistics Service reported in their Floriculture Crops 2002 Summary (USDA, April 2003) that the total crop value at wholesale for all floriculture growers with $10,000 or more in sales was $4.88 billion for 2002. The total value of sales of propagative plant material for cut flowers, potted flowering plants, annual bedding and garden plants, herbaceous perennials, foliage, and cut cultivated greens for 2002 was $332 million, 6 percent above the previous year. Annual bedding and garden plants accounted for 50 percent of all propagative material, or $167 million. These propagation numbers probably far underestimate the economic value of the seedling and cutting industry for vegetable, woody ornamental, and fruit production. In 2005, U.S. greenhouse growers imported 868 million unrooted cuttings of ornamental annuals and perennials (USDA 2006).

Many horticultural and agronomic crops are produced from seeds, cuttings, or tissue culture plantlets, each of which is considered a different horticultural category of plant propagative material.

A cutting is a section or portion of a plant removed for propagation or other purposes. A cutting has the ability to grow its own roots when taken from a clonable plant if cared for in a properly controlled environment. A common method for propagating certain plants is to raise plants for cuttings, cut a section or portion of the plant, root the cuttings, and then plant the rooted cuttings in a growth medium and allow them to grow into a plant.

Tissue culture plantlets are produced under controlled laboratory conditions, typically in gel or liquid culture, using plant hormones and nutrient solutions to encourage shoot and root development. The tissue culture plantlets are then transplanted in a protected greenhouse or nursery environment under a controlled environment to minimize transplant stress.

Seeds are produced from parental plants, can sometimes be dried and stored, and require specific environmental conditions for uniform and rapid germination in greenhouse, nursery, or field conditions.

Propagative material, including plant cuttings, seeds, and tissue culture plantlets, therefore require strict environmental controls and standards to result in high quality plant products with healthy root and shoot growth.

The location where propagative material is produced is often not the same as where the plants are grown on to develop roots. In fact, many greenhouses that produce seeds, cuttings and tissue-cultured material for horticultural species are located off-shore (for example, Canada, Costa Rica, Denmark, Guatemala, Israel, Kenya, Mexico), although some are located domestically. For example, chrysanthemum cuttings are obtained from plants grown in African and South American countries, whereafter the cuttings are transported by air to the Netherlands, where the cuttings are rooted.

Cuttings or tissue-cultured materials are normally taken from stock plants grown in a greenhouse and then shipped unrooted or with minimal rooting (i.e., by airfreight, train, etc.) to a second greenhouse to encourage root formation. At the second greenhouse location, often several days later, the cuttings are placed in small cells within trays, called plugs or liners, which contain a growing medium. Plants in the trays are then placed under high humidity to germinate or produce roots, and subsequently grown up to a saleable “young plant” in 4-6 weeks. The young plant is then transplanted from the individual cells into the field for production or into a larger container for further growth for the consumer.

According to common practice, when transporting cuttings to a location that would encourage root production in the cuttings, such cuttings are put into bags or wrapped in plastic to avoid dehydration. The bags are then placed in cardboard boxes and then transported, mainly by air, to the location where rooting will take place. Here the bags with the cuttings are taken out of the boxes, placed into growing media, and the cardboard boxes are taken away as waste.

For tissue-cultured material, plantlets are normally transported in rigid containers containing gel, liquid, or individual plantlets. The containers are then placed in insulated boxes and are then transported, mainly by air, to the location where rooting will take place.

Seeds are typically stored in bags in a dried state, transported by air, truck, or ship, and then placed into a hopper or other container and sown by hand or using an automated or mechanical seeder.

These systems and methods for processing and shipping propagative material are unfavorable in view of the following:
Following receipt of the cuttings or tissue-cultured plantlets, they must be placed in growing media to produce roots. Labor cost in the U.S. for sticking cuttings and tissue-cultured plantlets into media is high. There is increasing competition for low-wage labor, and immigration law may impact supply of this labor.
It is difficult to automate transplanting of unrooted cuttings and tissue-cultured plantlets because the stem base differs between species and the stem is easily damaged.
Shipping of unrooted material costs little, but shipping rooted liners is expensive and bulky.
Greenhouse space is expensive. Current crop production time in the U.S. takes 4-6 weeks for annual cuttings.

Accordingly, an improved system and method for processing and transporting new cuttings, seeds, and tissue-cultured plantlets are needed that is uncomplicated, that can be automated, and inexpensive to implement.

### BRIEF SUMMARY

The present invention provides devices and methods for more efficient handling of individual transplantable cuttings, tissue-cultured plantlets, or seeds (collectively termed propagative material). With the subject invention, multiple cuttings, tissue-cultured plantlets, or seeds can be more efficiently transplanted into multiple tray cells. It can also allow plants to start the rooting process immediately after cutting at an initial location, and before shipping to a growing-on location, often forming roots within approximately 7-14 days. This can lead to more rapid production time and allow more crops to be grown within a season in the growing-on location.

The device of the subject invention is a propagation string or “prop-string” for transplanting multiple plant cuttings, tissue-cultured plantlets, or seeds. The prop-string comprises a propagation strip or “prop-strip” having multiple propagation tubes or “prop-tubes.” The prop-tubes are preferably degradable or biodegradable, protective sheaths or collars into which cuttings, tissue-cultured plantlets, or seeds are placed prior to being transplanted. In certain embodiments, the multiple prop-tubes are joined and held together on a prop-strip via propagation strip tabs or “prop-strip tabs.” The configuration of the prop-string can allow more efficient manual transplantation of cuttings, tissue-cultured plantlets, or seeds. It can also facilitate the automation of the transplant process by machine. For example, in one embodiment the prop-tubes are arranged on a prop-strip in an ammunition belt-like configuration that permits a prop-string to be fed into automatic transplant machines or equipment.

In a further embodiment, the prop-tubes can be formed from a solid, continuous strip of material. In this case, prop-strip tabs can be excluded, and the prop-tubes can be removably connected to each other along the prop-strip.

In addition, because the prop-tubes of the subject invention can be placed on a prop-strip relatively close together, requiring little space in-between each prop-tube, transplant liner tray cells can be more compactly spaced within trays. This can allow more plants to be shipped in the same volume, which can lower costs. Thus, the subject invention further includes a cell tray having closer placed cells that further comprise design features that permit them to be utilized with a prop-string, accommodating prop tubes affixed to a prop-strip. The prop-tubes affixed to the prop-strip used in conjunction with a more compact tray configuration enable multiple cuttings to be transplanted at one time, with more plants per volume. In fact, in certain embodiments, the prop-tubes can be formed from a solid, continuous strip of material, further minimizing the space between the prop-tubes.

The prop-strip of the subject invention preferably will not restrict long-term growth or harm cuttings, does not require a growing media, and can accommodate a variety of diameters of cutting stems, tissue-culture plantlets, or seeds. Further, the shape and dry weight composition of the prop-tube can provide it with a lower volume and weight, which can reduce shipping costs.

### BRIEF DESCRIPTION OF DRAWINGS

In order that a more precise understanding of the above recited invention is obtained, a more particular description of the invention briefly described above will be rendered by reference to specific embodiments thereof that are illustrated in the appended drawings. Understanding that these drawings depict only typical embodiments of the invention and are not therefore to be considered as limiting in scope, the invention will be described and explained with additional specificity and detail through the use of the accompanying drawings in which:

FIG. 1 shows an embodiment of a prop-string of the subject invention.

FIG. 2 shows an embodiment of a prop-string of the subject invention aligned with a transplant liner tray.

FIG. 3 shows an embodiment of a transplant liner tray of the subject invention having frame notches.

FIG. 4 shows an embodiment of a transplant liner tray of the subject invention having frame notches. The figure illustrates how the frame notches can accommodate a prop-string.

FIG. 5 shows an embodiment of a multiple dibbler of the subject invention.

FIG. 6 shows multiple dibble holes created by using the multiple dibbler shown in FIG. 5.

FIG. 7 shows a nested configuration of an embodiment of the prop-string of the subject invention.

FIG. 8 illustrates one embodiment a prop-string of the subject invention. In this embodiment, a prop-string can be configured with 17 prop-tubes approximately 20 mm apart.

FIG. 9 shows an embodiment of prop-strings of the subject invention, wherein the prop-tubes are positioned on a prop-strip so as to be aligned with the cells of a transplant liner tray.

FIGS. 10A and 10B show transplanted cuttings within prop-tubes of the subject invention planted at different depths within liner tray cells.

FIG. 11 shows an embodiment of a prop-tube of the subject invention comprising organic materials. Shown is a prop-tube comprising balsa wood used with Calibrachoa cuttings.

FIG. 12 shows an embodiment of a prop-tube of the subject invention comprising a solid piece of corn starch biodegradable foam through which cuttings have been pushed through until the base protrudes from the bottom of the prop-tube.

FIG. 13 shows an embodiment of a prop-tube of the subject invention comprising a solid piece of high-density floral foam (Oasis flora foam) through which cuttings have been pushed through until the base protrudes from the bottom of the prop-tube.

FIG. 14 is a photograph showing an example embodiment of a prop-tube having a hollowed-out top end 22, a notch 26 and a stem groove 28.

FIG. 15 illustrates a top-end view of the embodiment shown in the photograph of FIG. 14.

FIG. 16 shows an example of cuttings placed at an appropriate depth within tray cells to ensure proper root development.

FIG. 17 illustrates an embodiment of a transplant tray liner of the subject invention wherein the cells are more compact than standard liner trays and are longer than they are wide to provide sufficient growth medium for cuttings.

FIGS. 18A-C show transplanted cuttings affixed to the prop-strings that aid in supporting the cuttings in an upright position during the transplant process. Used in conjunction with a transplant liner tray notch, the prop-string can aid in placement and support of propagative material during the transplant process.

FIG. 19 illustrates an embodiment of a prop-tube formed from the same material (high-density floral foam) as the prop-strip material. In this embodiment, adhesive would not be required to attach the prop-tube to the prop-strip because they would be manufactured as a single unit.

FIGS. 20A-B show an embodiment of a prop-strip formed from polyvinyl alcohol (PVOH) water-soluble tape (A) or a combination of PVOH water-soluble tape and a rigid plastic (B).

FIGS. 21A-D show an embodiment of a prop-strip in an “ammunition belt” configuration, showing a cross-sectional plan view (A), a side view (B), and (C) an example of cuttings arranged at high density in a prop-string similar to diagrams (A) and (B). In this embodiment, the prop-string can be fed into an automatic transplant machine. The prop-strip can be cut or torn into individual prop-tubes, which can then be transplanted into cells. This design has the advantage of high-density packing of propagative material, for example in a connected series of prop-strings on a grid (D) which can reduce shipping cost.

FIGS. 22A-D show an embodiment of a prop-strip in a “continuous solid strip” configuration, showing a top view (A), side view (B), close-up side view (C), and a solid rectangular-section strip of peat/polymer (D). In this embodiment, the prop-string can be fed into an automatic transplant machine. The prop-strip can be cut or torn into individual prop-tubes, which can then be transplanted into cells.

### DETAILED DISCLOSURE

In general, the subject invention provides a system comprising various embodiments of methods and devices for handling and transplanting plants, or cuttings, seeds, or tissue-cultured plantlets thereof (collectively termed propagative material). More specifically, the subject invention pertains to a method of propagating plants or propagative material utilizing one or more embodiment(s) of a new type of propagation tube and specific devices that can be used in conjunction with the propagation tube. In one embodiment, a series of the propagation tubes disclosed herein are connected for handling several cuttings, tissue-cultured plantlets, or seeds at once after they have been harvested, during transport to other locations, and for transplanting. The devices and methods of the subject invention are capable of supporting plant root growth and can provide a more efficient and cost effective way to handle and transplant plants or propagative material.

The subject invention is particularly useful in the field of horticulture, specifically in greenhouses. The devices are particularly useful for the handling of propagative material, including, but, not limited to, harvesting, shipping, and transplanting of plants, plant cuttings, tissue-cultured plantlets, seeds, and plants propagated therefrom. However, a person with skill in the art will recognize numerous other uses that would be applicable to the devices and methods of the subject invention. Consequently, this invention can be used in industrial or business applications other than those disclosed herein. In any event, the methods and devices disclosed herein can be used in a variety of situations that require handling of plants or propagative material.

References to “first”, “second”, and the like (e.g., first and second components), as used herein, and unless otherwise specifically stated, are intended to identify a particular feature of which there are at least two. However, these references are not intended to confer any order in time, structural orientation, or sidedness (e.g., left or right) with respect to a particular feature.

The term “propagative material”, as used in the subject invention, refers to plant cuttings, plant seeds, tissue-cultured plantlets, and/or any other material capable of growing into a plant.

The terms “plant”, “cutting”, or “propagative material” as used in the subject invention, are merely for literary convenience. The terms should not be construed as limiting in any way and may be used interchangeably in certain contexts in the subject application. The devices, apparatuses, methods, techniques and/or procedures of the subject invention could be utilized with any plant or propagative material capable of benefiting from the unique and advantageous methods and devices disclosed herein.

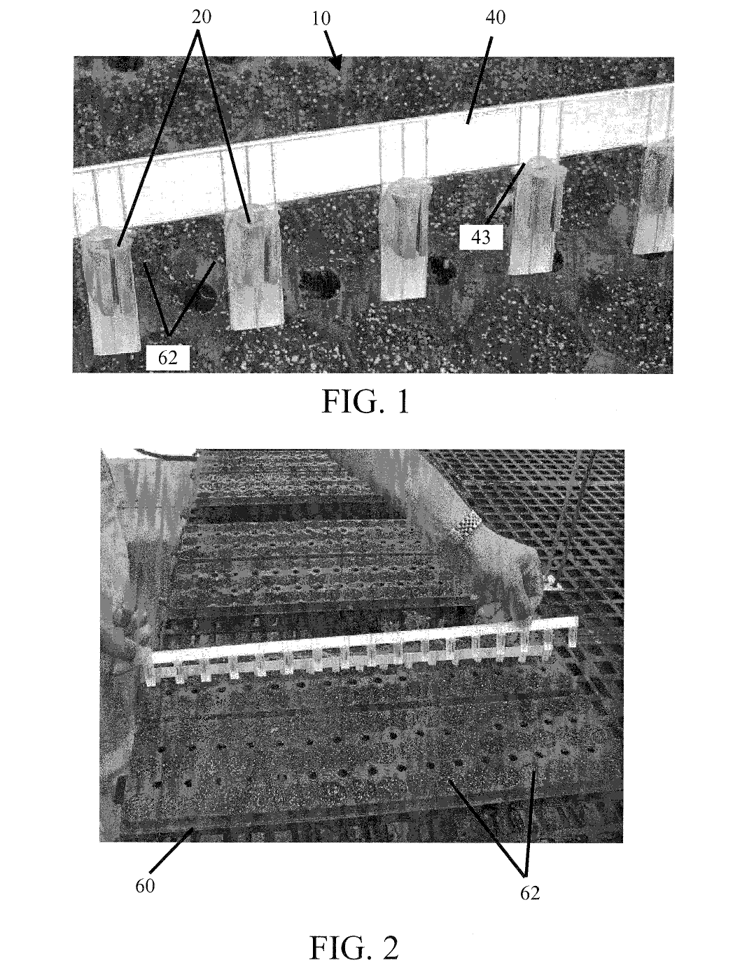

With reference to the attached figures, which show certain embodiments of the subject invention, it can be seen that the subject invention comprises a system for handling plant propagative material utilizing uniquely designed components. A first component is a propagation string, referred to herein as a prop-string 10. A prop-string includes one or more propagation tubes, referred to herein as a prop-tubes 20, as well as a propagation strip, referred to herein as a prop-strip 40, to which can be affixed at least one prop-tube 20, as shown, for example, in FIG. 1.

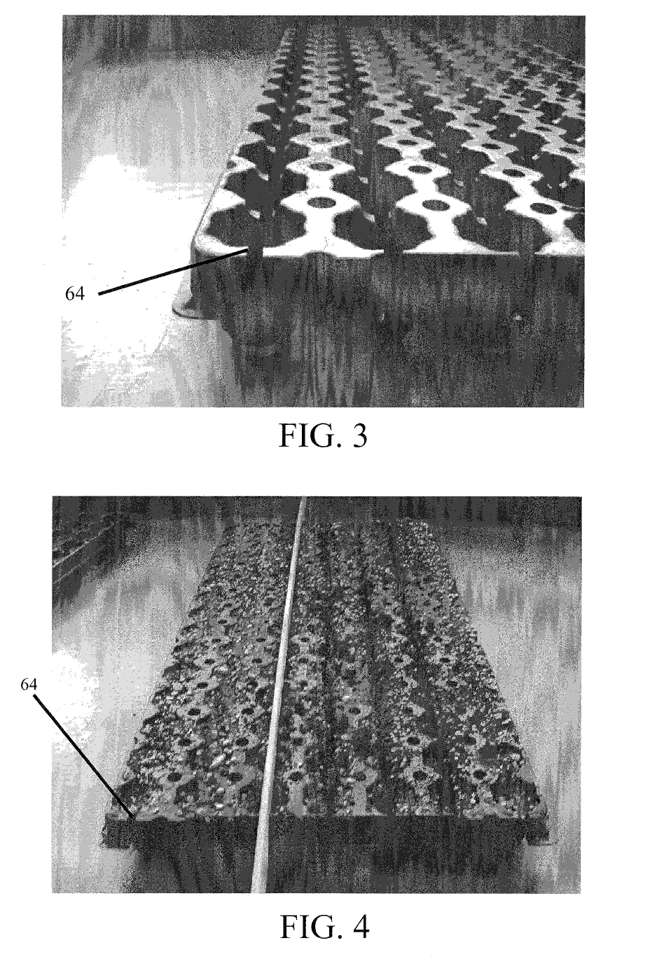

A second component of the system is a transplant liner tray 60 designed so that the at least one prop-tube of a prop-string can be aligned with one or more cells 62 in the transplant liner tray. As can be seen in FIG. 2, the alignment of the prop-tubes 20 with the cells 62 of a transplant liner tray 60 facilitates the simultaneous transplanting of a plurality or “string” of propagative material into a plurality of transplant liner tray cells 62. In one embodiment, the transplant liner tray 60 of the subject invention comprises a string-groove 64, an example of which can be seen in FIGS. 3 and 4, that can accommodate the prop-strip 40 of a prop-string 10 allowing propagative material in the prop-tubes 20 to be positioned a sufficient depth within the cells 62.

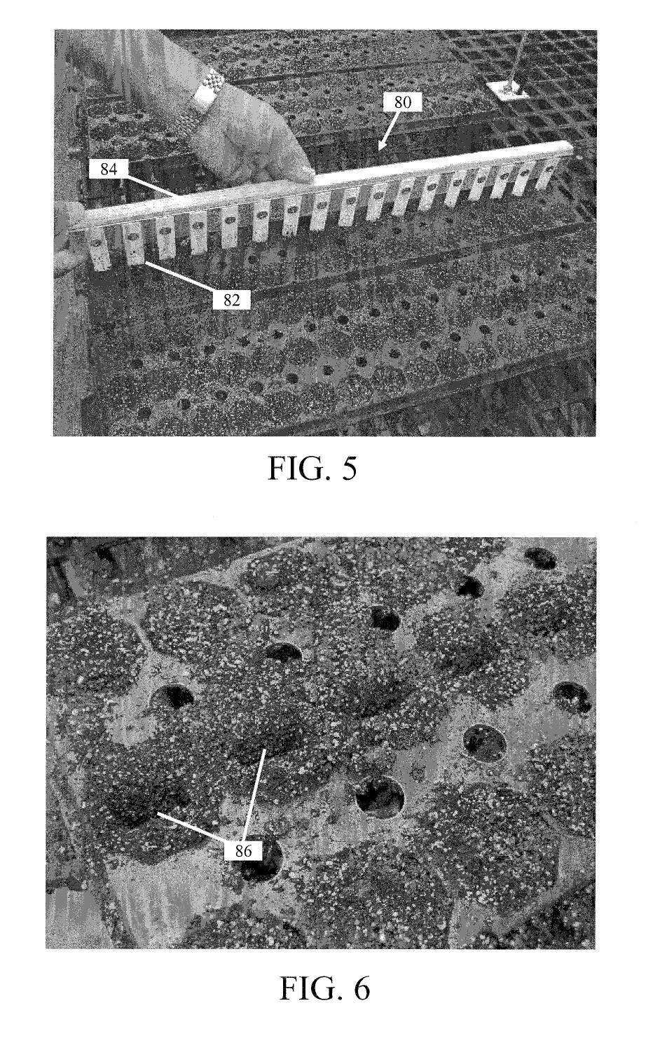

A third component of the system of the subject invention is a multiple dibbler 80. The multiple dibbler comprises a frame 84, similarly shaped as a prop-strip, with a plurality of dibblers 82 affixed thereto. The positions of the dibblers 8 on the frame 84 coincide with the positions of the prop-tubes 20 on a prop-string 10. The multiple dibbler 80 can be used to simultaneously dibble multiple cells 62 in a transplant liner tray. FIG. 5 shows an example of a manual dibbler that can be used with the system of the subject invention. FIG. 6 shows an example of dibble holes 86.

Following is a more specific discussion of each component of the system of the subject invention.

### I. The Prop-String

The prop-string 10 of the subject invention can be used for packaging and shipping mass quantities of propagative material in an efficient and cost effective manner. The system of using prop-strings can reduce the amount of handling required for each cutting, thus reducing labor costs. It is also an efficient packaging technique that reduces weight and increases the number of propagative material that can be shipped in a given volume, which can reduce overall costs.

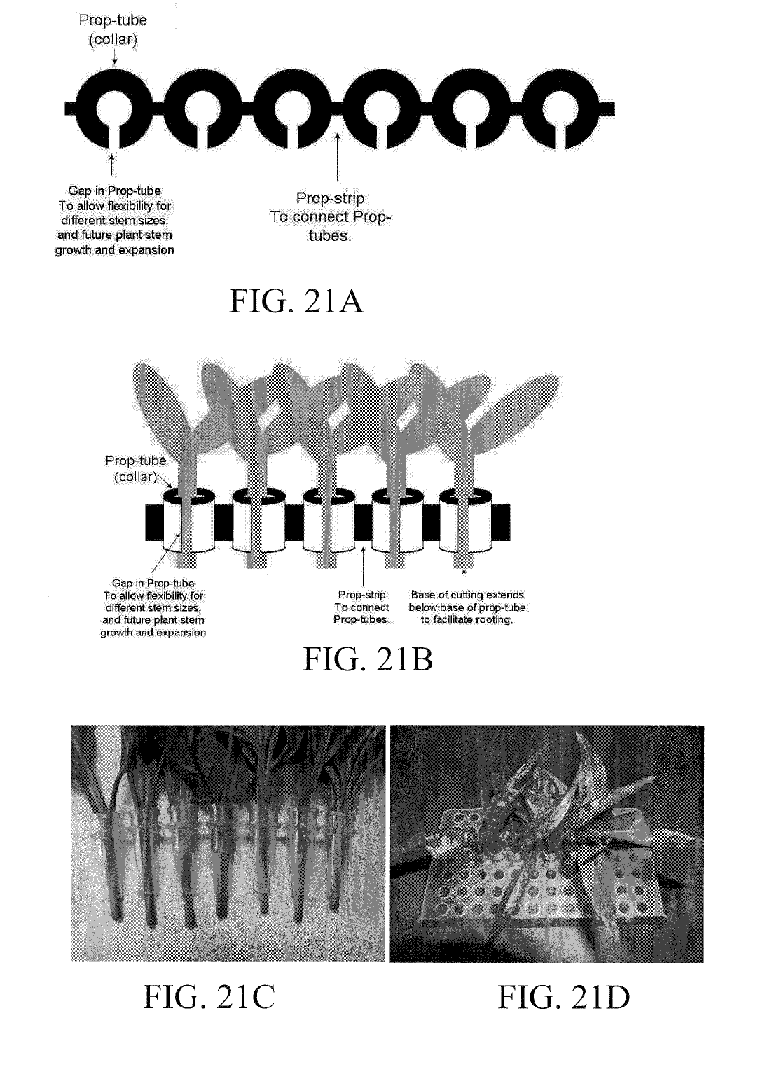

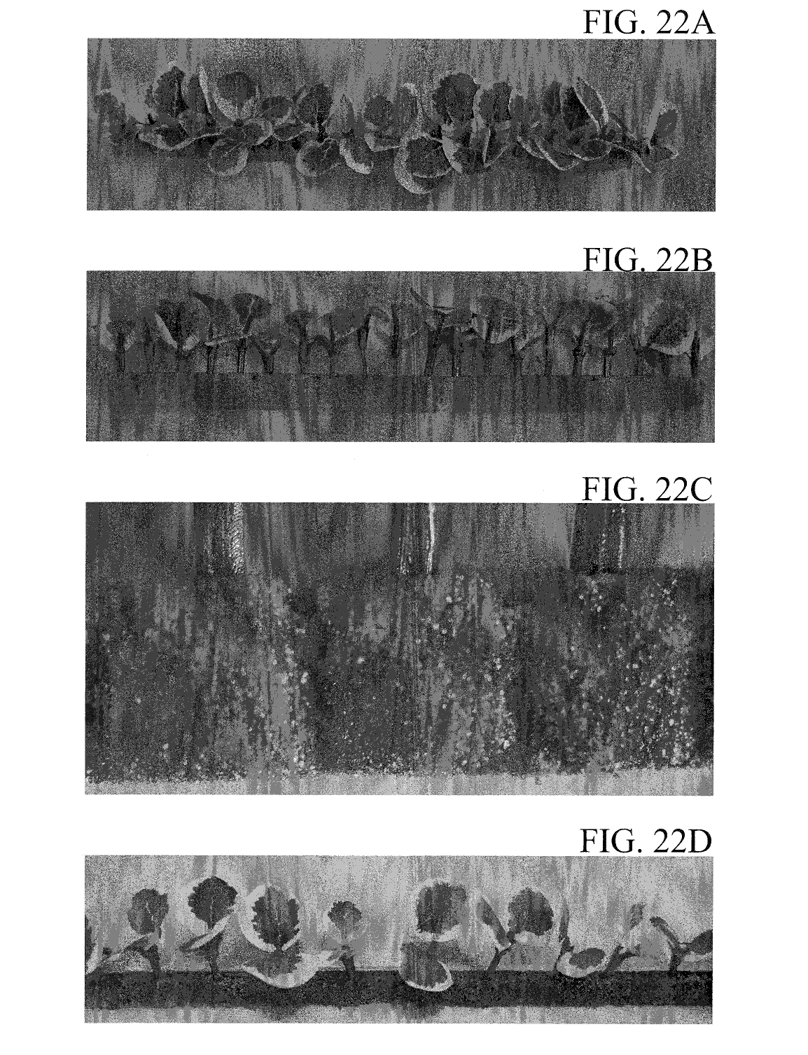

A prop-string 10 comprises a plurality of prop-tubes 20, which are collar-like devices, affixed to a prop-strip 40, forming a chain of connected prop-tubes 20. The distance between prop-tubes 20 affixed to a prop-string 40 can vary. But, the efficiency of the system of the subject invention resides, at least in part, in the ability to affix the prop-tubes to the prop-strip in a compact fashion, reducing the amount of space between each prop-tube, thus increasing the number of propagative material that can be stored and transported on each prop-string. Therefore, in one embodiment, prop-tubes are affixed to a prop-strip a sufficient distance apart to permit the placement of propagative material within the prop-tubes, either by hand or by machine, but also maximize the number of prop-tubes per prop-string. In a further embodiment, the prop-tubes are affixed to one side of a prop-strip, such that the prop-tubes are aligned along one side of a prop-strip, for example, as shown in FIG. 1, 12, or 19. But, in a further embodiment, the prop-tubes are arranged in an “ammunition-belt” configuration, wherein the prop-strip is centralized relative to the prop-tubes, for example, as shown in FIGS. 21A, B, and C. The prop-strips can be connected in a matrix formation to reduce shipping space (21D).

In yet a further embodiment, the prop-tubes can be continuous units along a solid strip of material, for example, as shown in FIGS. 22A-D. Thus, the prop-tubes can be removably connected to each other along a prop-strip.

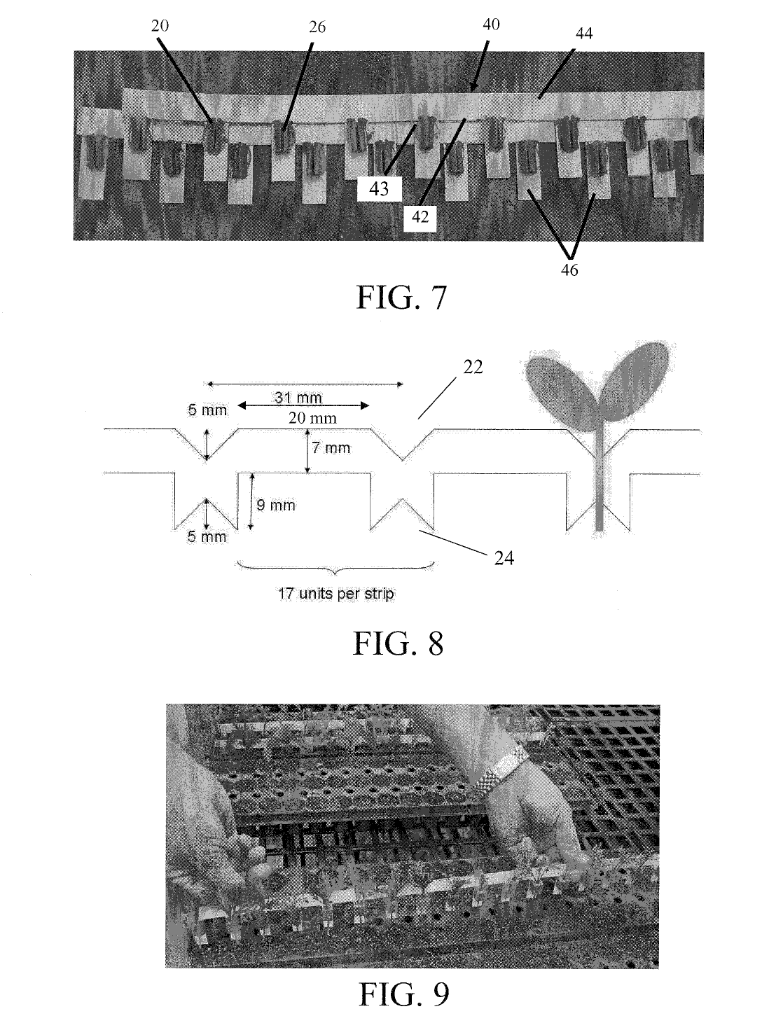

Once a prop-string is fully packaged with cuttings, it can be placed in a shipping container or other packaging for transport to the transplanting location. To further reduce shipping weight and volume, it can be advantageous to package multiple prop-strings within a container with minimal damage to the cuttings. Thus, a further embodiment of the subject invention utilizes prop-strings 10 that can be nested together, for example, as shown in FIG. 7. In this embodiment, the distance between the prop-tubes is sufficient to accommodate nesting of the prop-strings 10 in a generally over-lapping fashion, which places the prop-tubes of overlapping prop-strings in a relatively side-by-side position, as seen in the example in FIG. 7. In this embodiment, the distance between prop-tubes can be approximately equal to or slightly greater than the width of an individual prop-tube. This can maximize the number of prop-tubes on a prop-string and still permit prop-strings to be nested for transport. FIG. 8 illustrates a specific, but non-limiting, example of a prop-string 10 that can be configured with 17 prop-tubes, where each prop-tube is approximately 11.0 mm in width and placed a distance of approximately 20 mm apart.

Once the propagative material has reached the transplanting location, they are usually placed in transplant liner trays in a growing medium for development of a root system. The transplant liner trays comprise a plurality of individual cells into which are placed individual plants. At this point, the propagative material can be removed from the prop-tubes and transplanted into the cells. But, this can cause significant damage to the propagative material particularly if done after initiation of root development. Therefore, in a further embodiment of the system of the subject invention, the propagative material remains in the prop-tubes 20 and the prop-tubes are removed from a prop-strip 40 prior to transplanting. In an alternative embodiment of the system of the subject invention, a prop-string 10 can be severed between each prop-tube, leaving the prop-tube affixed to only a portion of the prop-strip 40, prior to transplanting.

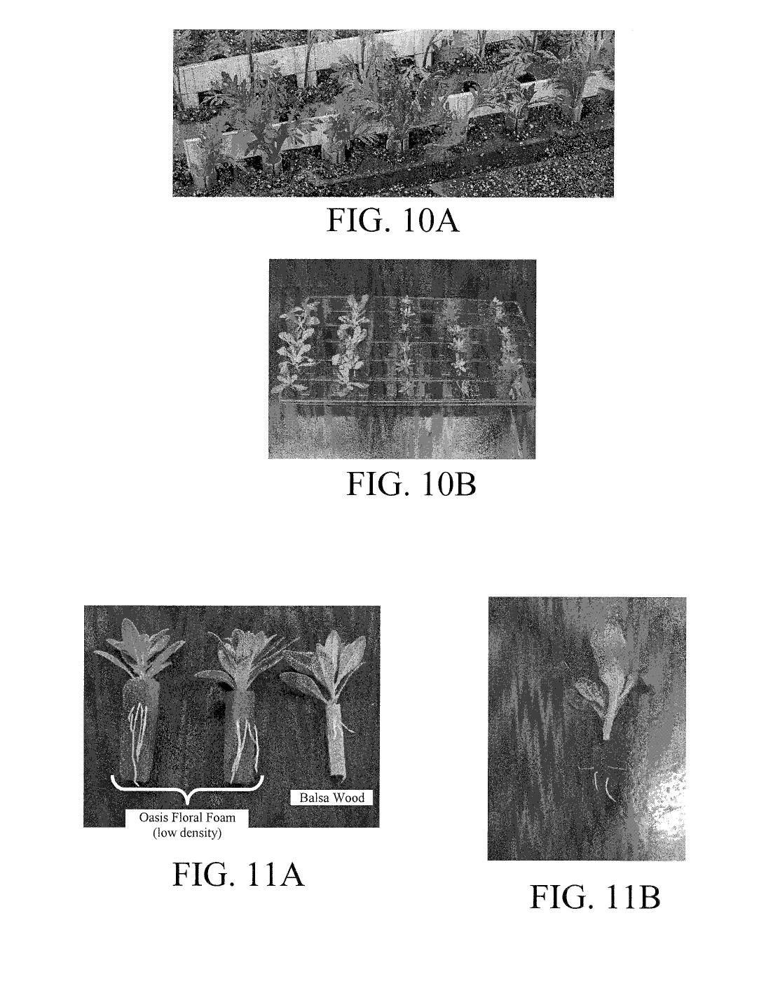

It would be particularly advantageous if the transplant process were made more efficient with less handling of individual cuttings, tissue-cultured plantlets, or seeds. Thus, in a further alternative embodiment, the prop-strings 10 can be configured so that the prop-tubes 20 are aligned with the cells of a transplant liner tray, for example, as shown in FIG. 9. Once aligned with a prepared tray, the prop-string can be settled over the tray allowing the prop-tubes to be properly positioned within the cells. Growing medium can be placed in the cells either before or after the propagative material is positioned therein. Examples of transplanted cuttings in prop-tubes 20 are shown in FIGS. 10A and 10B.

In a further embodiment, discussed in more detail below, the prop-tubes 20 can be affixed to the prop-strip 40 so that they are below, or hang-down from, the bottom edge 62 of the prop-strip. This permits the prop-tubes 20 to be positioned a sufficient depth in transplant liner tray cells. In a still further embodiment, discussed in more detail below, a transplant liner tray can be modified to better accommodate prop-strings and allow the prop-tubes to be placed a sufficient depth in the tray cells.

The prop-strings of the subject invention can be manipulated manually for the simultaneous transplanting of a plurality of propagative material. For example, multiple prop-tubes can be transplanted from a single prop-string simultaneously or a single prop-tube from each of multiple prop-strings can be transplanted simultaneously. This can increase the efficiency, and, thus, reduce the overall costs of the transplant process. In addition, certain embodiments of the prop-strips, for example, as shown in FIGS. 21A, B, C, facilitate the use of automatic machinery for the transplant of multiple cuttings, tissue-cultured plantlets, or seeds. Currently, there are several companies that manufacture greenhouse automation equipment. For example, Visser is a Dutch greenhouse automation company that manufactures automated cutting transplanters for chrysanthemums. There are also automatic systems available for transplanting cactus cuttings, as well as other types of plant cuttings or automatic transplanters. Utilizing the integrated designs of a prop-string and a transplant liner tray, it would be well within the skill of a person trained in the art to devise automatic equipment for use with the subject invention, or to utilize known equipment with the prop-string of the subject invention. Such a device(s) could manipulate and transplant a multitude of prop-strings and could, if necessary, also cut or remove a prop-strip to separate each cutting, tissue-cultured plantlet, or seeds. In a further embodiment, the prop-strip can be cut and the individual prop-tubes transplanted into transplant liner tray cells. This would still permit high-density packaging of propagative material, but allow growers to utilize standard transplant trays for transplanting and growing propagative material.

### A. The Prop-Tube

The prop-tube 20 of the subject invention is a collar or sheath-like device for holding propagative material during transport. Whether traveling a few feet or several thousand miles, it is important that the prop-tube be able to hold the propagative material firmly without causing abrasion, constriction, stem break, or other damage. In certain embodiments, a prop-tube is generally a collar holding propagative material and does not necessarily comprise a growing medium. But, in certain other embodiments, a prop-tube can comprise one or more materials that promote root development. For example, any of a variety of natural or artificial chemical additives can be incorporated with the material(s) of a prop-tube, or otherwise used with a prop-tube 20 and prop-string 40 embodiments of the subject invention, including, but not limited to, rooting hormones, fungicides, growth retardants, or a nutrient charges. FIGS. 11A and 11B show example embodiments of prop-tubes in which cuttings placed therein have initiated root development. In either embodiment, it is possible that root development can initiate soon after harvesting, particularly with certain types or varieties of plants. Prop-tubes 20 of the subject invention can also minimize movement of the cutting within the prop-tube, so as to avoid damage to any root development that may occur. This can be achieved with prop-tubes that surround at least a portion of a cutting stem and are able to conform to the shape of the stem. In a further embodiment, a prop-tube comprises one or more materials that permit root development through and around the prop-tube material. For example, in one embodiment, a prop-tube can comprise any of a variety of porous materials that provide sufficient aeration to promote the development of roots within the material(s). In a still further embodiment, a prop-tube comprises one or more materials that accommodate later plant growth, by expansion or biodegradation.

Because a prop-tube will be transported with propagative material, further embodiments comprise one or more materials having minimal volume and dry weight to reduce transport costs. However, because of phytosanitary restrictions and other restrictions on the importation of various biological products, utilizing organic materials, growing medium, or any materials capable of supporting microbial life or growth may not be feasible for such uses. As mentioned above, in the horticultural industry, it is common for propagative material to be harvested in one location or country, transported to another location or country for transplanting, and then exported again to various countries for sale or field planting. Therefore, while biodegradable materials (those degraded by microbial action) would not be feasible for certain import/export businesses, the use of one or more degradable materials (those degraded by chemical action) can be acceptable and useful for the prop-tubes of the subject invention. For example, water-soluble materials and UV-degradable materials can be used for the prop-tubes of the subject invention.

Therefore, embodiments of the prop-tube preferably comprise any of a variety of degradable materials. In certain embodiments, prop-tubes can be manufactured from materials that are not easily degraded, such as, for example, rubbers, plastics, nylon, and various polymers, and other not easily degradable materials. In further embodiments, prop-tubes can be manufactured from variably degradable materials, such as, for example, any of a variety of polymers, papers, or solid, foam-like, porous materials, such as, for example, high-density Oasis floral foam, which are relatively easily degradable. Alternative embodiments can also utilize various types of binder material mixed with filler. For example, in one embodiment, sterile agars, gelatins or cornstarch binders can be combined with vermiculite or sterile sawdust and formed into prop-tubes.

Alternative embodiments can utilize one or more materials that contain or support microbial life for the manufacture of prop-tubes. For example, prop-tubes that would not be subject to import/export restrictions could comprise any of a variety of organic materials, including growing media, various plant material(s), or other materials capable of supporting microbial life. Thus, in one embodiment balsa wood can be used to manufacture prop-tubes and can promote root growth, as seen in the Calibrachoa cuttings in FIG. 11A. In an alternative embodiment, various peat-based media can be used to manufacture prop-tubes, for example, as shown in the peat/polymer of the continuous string of prop-tubes in FIG. 22D. A person with skill in the art and benefit of the subject disclosure would be able to determine various alternative organic materials for the manufacture of prop-tubes and such variations are considered to be within the scope of the present invention.

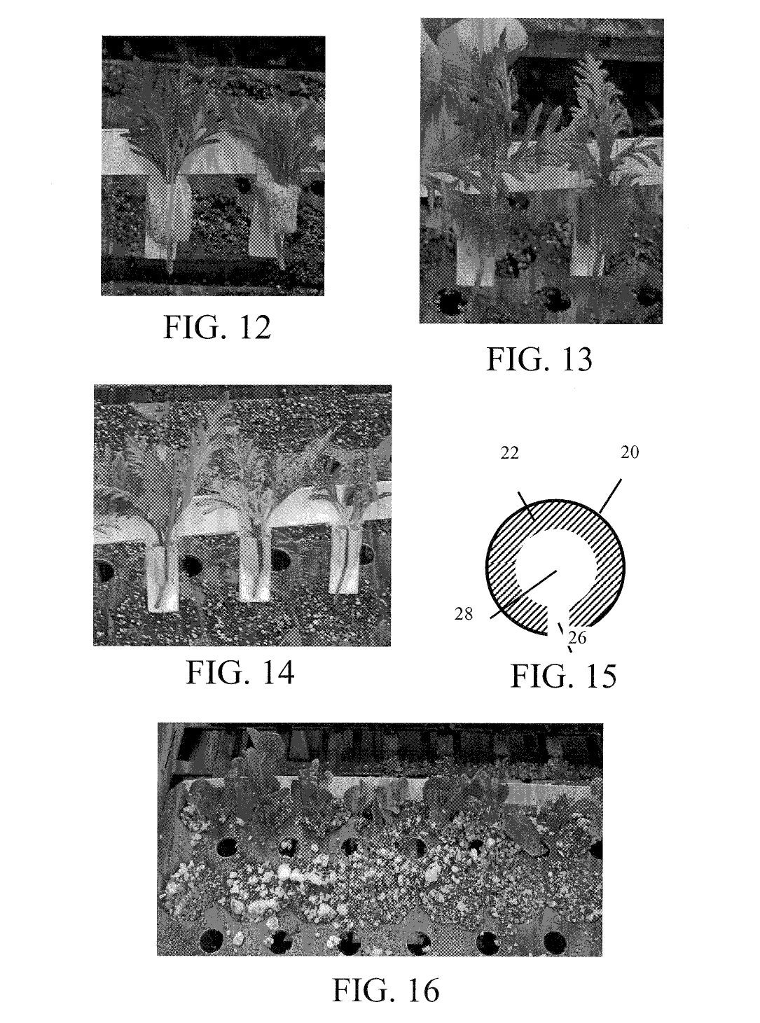

The dimensions of a prop-tube 20 of the subject invention can vary depending upon a number of factors such as, for example, the stem size of cuttings, the flexibility of the manufacturing material, expected time before transplant, probability of root development, transport method and costs, as well as other considerations. In one embodiment, a prop-tube can be a solid material having a density that permits cuttings to be pushed into the material. In a further embodiment, a prop-tube can comprise dimensions that permit a cutting to be pushed through the material such that the base of the cutting protrudes from the prop-tube. For example, FIGS. 12 and 13 show embodiments of prop-tubes comprising solid, porous materials through which cuttings have been pushed until the base protrudes from the bottom of the prop-tube. This can aid in later root development when cuttings are transplanted.

In a further embodiment, a prop-tube can be formed with a partially hollowed-out, or concave top end 22 and/or bottom end 24, for example, as shown in FIG. 8. This embodiment can reduce the amount of material that a cutting stem has to be pushed through, but still provide protection and support around the stem. These embodiments can ensure that root development is not hampered and can occur at any point along the stem, including including the portion of the stem not within the prop-tube, as well as that portion in contact with a prop-tube.

For some cuttings, particularly those with softer, or easily damaged, stems, it may not be possible to push the stem through the material of a prop-tube. Thus, in an alternative embodiment, a prop-tube can have a central hole or stem groove 28 that traverses the length of the prop-tube 20. A stem groove 28 can reduce or eliminate damage to cutting stems, particularly soft cutting stems, caused by being pushed through a prop-tube. In a further embodiment, prop-tubes can be manufactured with various stem groove 28 sizes to accommodate different sizes of cuttings. And, in a still further alternative embodiment, the stem groove is tapered such that the top end 22 has a larger diameter than the bottom end 24. A wider top facilitates placement of the propagative material within the prop-tube and a narrower bottom can ensure that the propagative material is held in place within the prop-tube 20.

In a further embodiment, a prop-tube can be split along one side to form a notch 26 within the prop-tube 20 that is contiguous with the stem groove 28. The notch 26 allows the prop-tube to open or widen to accommodate different sizes of cutting stems or when the transplanted cuttings begins to grow. FIG. 14 is a photograph and FIG. 15 is a top-end 22 view of an embodiment of a prop-tube having a hollowed-out top end 22, a notch 26 and a stem groove 28.

In certain embodiments, the prop-tubes can be removably connected to the prop-strip. In a specific embodiment, the prop-tubes can be connected to the prop-strip tabs which can be removably connected to the prop-strip. In a further embodiment, the prop-tubes can be removably connected to each other along the prop-strip.

An exemplified embodiment comprises a prop-tube 29 having a top end 22 to bottom end 24 length of between approximately 1.0 cm to approximately 1.5 cm, and a diameter of between approximately 0.6 cm to approximately 0.8 cm. And, in a further exemplified embodiment, a prop-tube can have a stem groove 28 that is circular and tapered having a top end 22 diameter of between approximately 1.5 mm to approximately 3.5 mm and a bottom end 24 diameter of between approximately 1.0 mm to approximately 3.5 mm.

In certain embodiments, a prop-tube can have cross-sectional dimensions of about 5 mm to about 25 mm by about 5 mm to about 25 mm (such that the width of each prop-tube is from about 5 mm to about 25 mm and the length of each prop-tube is from about 5 mm to about 25 mm).

In a specific embodiment, a prop-tube can have cross-sectional dimensions of about 9 mm by about 9 mm. A prop-tube can be composed of a flexible polymer or polymer/peat blend (FIG. 22). For example, a continuous form prop-strip, as shown in FIG. 22D, can include prop-tubes each having cross-sectional dimensions of about 9 mm by about 9 mm, which can provide adequate spacing for cuttings of many annual plant species (cuttings from about 1 mm to about 30 mm; and more specifically from about 5 mm to about 20 mm). In further embodiments, the cross-sectional dimensions of a prop-tube can be larger or smaller.

In one embodiment, dibble holes can be provided in the prop-tubes. The dibble holes can have a tapered or star-cut shape to accommodate propagative material of a wide range or diameters. The tapered shape can be, for example, a hole with a diameter of about 1.5 mm at a top portion tapering to a diameter of about 0.5 mm at a bottom portion (which can accommodate smaller annual plant cuttings). In an alternative embodiment, the tapered shape can be a hole with a diameter of about 3 mm at a top portion tapering to a diameter of about 1.5 mm at a bottom portion (which can accommodate larger-diameter cuttings). The listed diameters for the dibble holes are provided by way of example only, and embodiments of the present invention are not limited thereto.

### B. The Prop-Strip

The prop-strip 40 of the subject invention is generally an elongated frame 44 to which a plurality of prop-tubes 20 can be affixed. In one embodiment, the prop-strip is a generally thin strip of material having two generally vertical sides, whereby prop-tubes can be affixed and arranged along one of the two sides. A prop-strip can comprise any of a variety of materials that are non-toxic to plants and suitable for holding, packaging, transporting, and transplanting prop-tubes 20 and cuttings therein. Further, once transplanted, it can beneficial if the individual prop-tubes can be separated by either manual methods (cutting, splicing, tearing) or by natural degradation (i.e., chemical decomposition) or biodegradation (microbial decomposition) or dissolution (in the case of water-soluble plastic), usually upon contact with growing medium. The composition of the prop-strip 40 can depend upon the anticipated time that propagative material is expected to be maintained within the prop-tubes 20 affixed to the prop-strip. For example, if the propagative material will be maintained in the prop-tubes until rooting occurs, then it would be preferable for the prop-strip not to degrade too quickly so that it can be used to simultaneously transplant the cuttings, as discussed above. However, if the propagative material will be transplanted relatively quickly, prior to significant root formation, then it can be beneficial for the prop-strip to comprise faster degrading or biodegrading materials.

In one embodiment, a prop-strip 40 can comprise cardboard containing products that are degradable upon contact with water or light, or that are biodegradable. This embodiment could be used in situations where cuttings will be transplanted relatively quickly after harvesting and will be maintained in transplant liner trays 60. This would provide time for the individual prop-tubes to be eventually separated as the cardboard product deteriorated. Any portions that had not been sufficiently degraded could easily be separated manually.

In an alternative embodiment, a prop-strip 40 can comprise any of a variety of plastics or similarly rigid or flexible (e.g. tape, as shown in FIG. 20A, or a plastic strip as shown in FIG. 22D) materials. Such materials can also be manufactured with degradable materials, or can be cut to separate prop-tubes. This embodiment could be used when cuttings will be maintained within prop-tubes for a longer period of time.

In a preferred embodiment, a prop-strip 40 has sufficient rigidity to maintain overall structure and shape of the prop-string 10 during use. A flexible material, such as the tape shown in FIG. 20A, can be used to construct the prop-strip. However, a more rigid material can be easier to handle. As discussed above, the prop-string is advantageous because it permits the simultaneous transplanting of a plurality of propagative material. This can be most easily accomplished if the prop-string has sufficient rigidity to permit the prop-tubes thereon to be lined-up with the cells of a transplant liner tray.

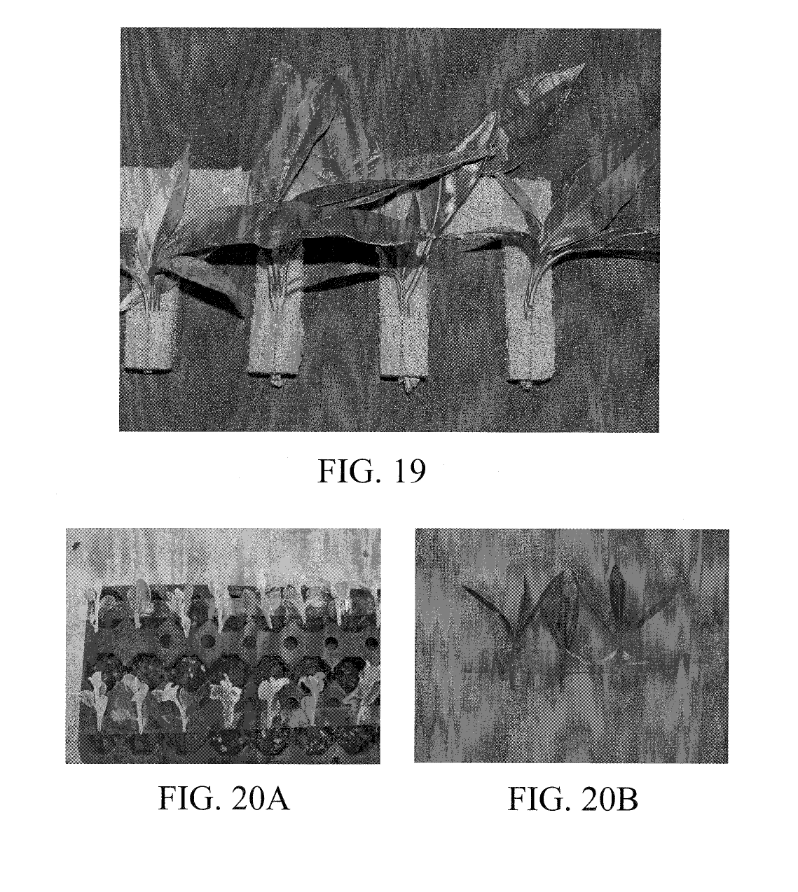

Prop-tubes 20 can be affixed to the prop-strip 40 utilizing numerous techniques and devices known in the art. In one embodiment, the prop-tube 20 is manufactured as a separate item from the prop-strip 40, as shown for example in FIG. 1. In this embodiment, the prop-strip 20 can be attached with an adhesive, which would preferably be water-soluble, biodegradable or degradable. FIG. 20B shows an embodiment of a prop-strip where water-soluble polyvinyl alcohol (PVOH) tape is used to adhere cuttings to the prop-strip. In an alternative embodiment, the prop-tube 20 can be molded, extruded or cut from the same material as the prop-strip 40, as shown in FIG. 19.

As discussed above, embodiments of the prop-tubes 20 of the subject invention can be transplanted along with propagative material into the cells of transplant liner trays. Therefore, it can be helpful if the propagative material and the prop-tubes are placed at a proper depth in the cells so that they are properly covered with growing medium. FIG. 16 shows an example of propagative material placed at an appropriate depth within tray cells to ensure proper root development.

In a further embodiment, a prop-strip 40 further comprises a plurality of prop-strip tabs 46 to which prop-tubes 20 of the subject invention can be affixed, as shown, for example, in FIGS. 1, 7, 12, 13, and 14. The prop-strip tabs 46, as shown in the figures, are affixed at or near their top edge 43 to the generally bottom edge 42 of the prop-strip and extend below the bottom edge 42 of the frame 44 so that when the prop-string 10 is lowered to place the prop-tubes 20 into tray cells 62, the frame 44 can come into contact with the edges of the transplant liner tray 60, but the prop-tubes can still be positioned at a proper depth within the cells, as shown, for example, in FIG. 10. The prop-strip tabs 46 can comprise the same or different material than the frame 44.

In a further embodiment of the subject invention, discussed below, a modified transplant liner tray can be used that permits the prop-string to be lowered past the edge of the tray cells. This can further aid in ensuring that the cutting is placed at a sufficient depth in the tray cells.

In a specific embodiment, a prop-strip can be made up of a continuous strip of material, as shown in FIGS. 22A-D. The prop-strip can have a rigid backing of any suitable thickness, for example, about 0.5 mm to about 5 mm. The rigid backing can be, for example, plastic or another rigid material. In an embodiment, the plastic backing can be biodegradable in the growing medium and/or in soil. The plastic backing can have several indexing grooves spaced apart by a width approximately equal to the width of each prop-tube to be placed on the prop-strip. The continuous strip can contain grooves or partial cuts between prop-tubes.

### II. The Modified Transplant Liner Tray

Another component of the system of the subject invention is a modified transplant liner tray 60, though embodiments of the present invention do not necessarily include this component. The prop-string 10 of the subject invention can readily be used with transplant liner trays known in the art. However, as mentioned above, one advantage of the system of the subject invention is the ability to place the prop-tubes 20 relatively compactly on a prop-strip, thus allowing more cuttings to be packaged in a given volume. But, the compact placement of the prop-tubes means that they may not align with standard transplant liner trays.

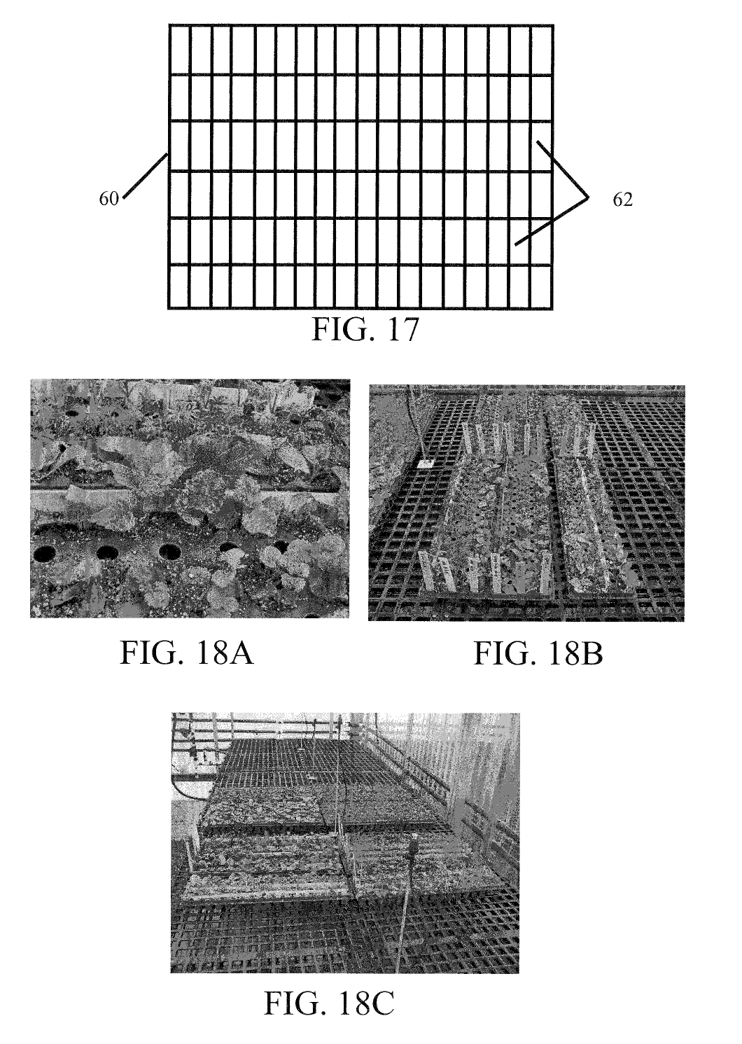

In one embodiment of the liner tray of subject invention, the cells 62 are placed closer together and in alignment with the prop-string, and prop-tubes thereon, that will be used with the liner tray. In this embodiment, the cells will necessarily be narrower, reducing the amount of growing medium within each cell. Therefore, in a further embodiment, the cells can be modified to be narrower along one side, to accommodate the compactness of prop-tubes, but longer along a second side to accommodate sufficient growing medium and encourage adequate root development. An example of this type of cell structure is shown in FIG. 17, where the prop-strip 40 would be transplanted in a horizontal orientation.

In a further embodiment, the transplant liner trays 60 of the subject invention comprise cut-outs on either side of the tray cells 62 that accommodate the frame 44 of the prop-string 10. Referred to as a frame notch 64, the cut-outs permit a frame 44 of a prop-string to be positioned below the level of the edge of the cells 62, which in turn can position the prop-tubes 20 deeper into the cells, ensuring proper coverage with growing media. In a further embodiment, the width of the frame notch 44 is equivalent to, or slightly larger than, the width of the frame 44 so that the edges of the frame notch 64 are able to support the entire prop-string 10 in a generally upright position, for example, as shown in FIGS. 18A-C.

Further, in the mechanization of the system of the subject invention, the frame notch 64 can assist in the automatic placement of the prop-string along a row of tray cells 62.

A transplant liner tray according to embodiments of the present invention can have any suitable number of cells. For example, a transplant liner tray can have 84 cells (7 rows of 12), 102 cells (in a 51-split tray with 6 rows of 17), 105 cells (7 rows of 15), or 50 cells (5 rows of 10), though embodiments are not limited thereto.

### III. The Multiple Dibbler

Another component of the system of the subject invention is a multiple dibbler 80, though embodiments of the present invention do not necessarily include this component. The multiple dibbler 80 is a device that can be used to form dibble holes in trays that are filled with loose growing medium. As discussed above, the system of the subject invention advantageously provides for the simultaneous planting or transplanting of a plurality of cuttings. In most transplant methods, growing medium is placed in cells first and the cuttings are then “stuck” or transplanted into this medium. This can be easily accomplished when cuttings are stuck individually.

The system of the subject invention can make it difficult for multiple cuttings within prop-tubes to be stuck in growing medium in the conventional manner because of the need for the prop-tubes 20 to be precisely aligned with holes in the growing medium. Therefore, the multiple dibbler 80 component of the subject system can be used to simultaneously create multiple dibble holes that are generally aligned with the prop-tubes 20 on a prop-string 10. FIG. 5 shows an embodiment of one multiple dibbler 80 device that can be used with the subject system. This embodiment utilizes dibbler tabs 82 affixed to a dibbler frame 84. The dibbler tabs 82 can be of approximately the same dimensions as prop-strip tabs 46, discussed above, so as to make dibble holes large enough to accommodate prop-tubes 20. A multiple dibbler can have any number of dibbler tabs 82 affixed thereto. But, in one embodiment, the multiple dibbler has the same number of dibbler tabs as a row of cells in a standard or modified liner tray 60. A person trained in the art having benefit of the subject disclosure would be able to create alternative multiple dibbler embodiments useful with the subject invention, and such variations are contemplated to be within the scope of the subject invention.

There are many ways to create dibble holes in trays. For example, dibble holes can be drilled out, they can be made manually or with a mechanical press, and in cases where the propagation media in the tray includes a polymer, dibble holes can be molded.

The following example illustrates procedures for practicing the subject invention. This example is provided for the purpose of illustration only and should not be construed as limiting. Thus, any and all variations that become evident as a result of the teachings herein or from the following example are contemplated to be within the scope of the present invention.

### EXAMPLE 1

### An Initial Greenhouse Trial

A prop-tube and prop-strip have been used that comprise a cardboard strip with prop-tubes affixed thereron. Several varieties of cuttings, including Bacopa, Bidens, Lantana, and Verbena cuttings were used with the prop-tubes. The cuttings were grown in a research greenhouse at the University of Florida research greenhouse facility. Unrooted cuttings were taken from stock plants grown also grown in a University of Florida greenhouse. The cuttings were placed into the different prop-tubes and prop-strips. Bacopa cuttings were double “stuck” meaning that there were two cuttings per cell for this small-stemmed plant. Blackmore 102-count propagation split-trays were used.

Treatments included:

Prop-Strips: No prop-strip used, cardboard prop-strip, plastic prop-strip. The cardboard was intended as an example of a prop-strip that would hold unrooted cuttings, be shipped, and then would biodegrade after being placed in the growing medium. The plastic was intended as a prop-strip that could be used to hold cuttings for initiation of roots, and then be shipped.

Prop-Tubes: No prop-tube, rubber tube, corn starch tube, Oasis foam tube.

Media: Peat-perlite-vermiculite growing medium, and perlite-vermiculite growing medium. Peat-perlite-vermiculite medium is used for commercial plant propagation in the U.S. Perlite-vermiculite was intended as a medium that would be washed from the cutting before shipping.

### Prop-Tube Compositions:

Gelatin or corn starch binder, mixed with vermiculite or sawdust. The glue dissolved with water. These were molded using a plastic pipette tray in a torpedo shape. A tube shape is preferred so that the bottom of the cutting is exposed. A more flexible formulation may be preferable.
A degradable rubber cutting holder. The hole is preferably adjustable for variable cutting sizes. In certain embodiments, a split side is provided in the holder so as not to restrict growth of the cutting over time.
Biodegradable polymer foam; preferably a molded foam. A cornstarch biodegradable foam is biodegradable and flexible. A polymer that is not a potential microbial food source is preferred. In the use of cornstarch, the polymer dissolves with water and leaves a hole in the medium. To address this, vermiculite or sawdust was included with cornstarch or gelatin.
Oasis-type high-density floral foam was acceptable.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

The invention has been described herein in considerable detail, in order to comply with the Patent Statutes and to provide those skilled in the art with information needed to apply the novel principles, and to construct and use such specialized components as are required. However, it is to be understood that the invention can be carried out by specifically different equipment and devices, and that various modification, both as to equipment details and operating procedures can be effected without departing from the scope of the invention itself. Further, it should be understood that, although the present invention has been described with reference to specific details of certain embodiments thereof, it is not intended that such details should be regarded as limitations upon the scope of the invention except as and to the extent that they are included in the accompanying claims.

I claim:

1. A device comprising:
an elongated prop-strip having a bottom edge and at least one side;
a plurality of prop-strip tabs each having a pre-determined width, a top and bottom edge and at least one side, said prop-strip tabs being affixed at or near their top edge to the prop-strip at regular intervals at least equivalent to the pre-determined width of a prop-strip tab, and such that the bottom edge of the prop-strip tabs extend below the bottom edge of the prop-strip, whereby a plurality of said devices can be arranged with overlapping, parallel prop-strips so that the prop-strip tabs of one device are nested between the prop-strip tabs of a second device; and
a plurality of prop-tubes affixed singly to the at least one side of each of the plurality of prop-strip tabs.

2. The device of claim I, wherein the elongated prop-strip, prop-strip tabs, or prop-strip tubes comprises one or more degradable materials.

3. The device of claim 1, wherein the elongated prop-strip, prop-strip tabs, or prop-strip tubes comprises one or more biodegradable materials.

4. The device of claim 1, wherein the elongated prop-strip, prop-strip tabs, or prop-strip tubes comprises one or more non-degradable materials.

5. A system for handling and transplanting plants comprising:
an elongated prop-strip having a bottom edge and at least one side;
a plurality of prop-strip tabs each having a pre-determined width, a top and bottom edge and at least one side, said prop-strip tabs being affixed to the prop-strip at or near their top edge at regular intervals at least equivalent to the pre-determined width of a prop-strip tab, and such that the bottom edge of the prop-strip tabs extend below the bottom edge of the prop-strip, whereby a plurality of said devices can be arranged with overlapping, parallel prop-strips so that the prop-strip tabs of one device are nested between the prop-strip tabs of a second device;
a plurality of prop-tubes affixed singly to the at least one side of each of the plurality of prop-strip tabs; and
a transplant liner tray having a plurality of cells arranged at intervals that facilitate alignment of the plurality of prop-tubes with said cells, such that the plurality of prop-tubes can be inserted substantially simultaneously into the plurality of cells.

6. The system, according to claim 5, wherein each of the cells of the transplant liner tray comprise a pre-dibble to assist in the insertion of prop-tubes.

7. The system, according to claim 5, further comprising a multiple dibbler having:
a rigid, elongated dibbler-frame having a bottom edge and at least one side;
a plurality of rigid dibbler-tabs each having a pre-determined width generally equivalent to the width of the prop-strip tabs, and a top and bottom edge, said dibbler tabs being affixed at or near their top edge to the dibbler-frame at regular intervals that correspond to the intervals between prop-strip tabs, such that the bottom edge of the dibbler-tabs extend below the bottom edge of the prop-strip.

8. A method for handling and transplanting plants comprising:
constructing and arranging a prop-string having a prop-strip with a plurality of prop-strip tabs affixed thereto and a plurality of prop-tubes each affixed to a prop-strip tab;
positioning a plant, cutting, tissue-cultured plantlet, or seed within at least one prop-tube of the plurality of prop-tubes;
aligning the at least one prop-tube, with the plant, cutting, tissue-cultured plantlet, or seed therein, with a plurality of cells in a transplant liner tray; and
inserting the plurality of prop-tubes, with the plant, cutting, tissue-cultured plantlet, or seed therein, into the plurality of cells of the transplant liner tray.

9. A device comprising:
a prop-strip comprising a plurality of prop-tubes connected to each other in series along the prop-strip.

10. The device, according to claim 9, further comprising a rigid backing having a length approximately equal to a length of the prop-strip, wherein the rigid backing is attached to a side of each prop-tube of the plurality of prop-tubes.

11. The device, according to claim 10, wherein the rigid backing has a thickness of about 0.5 mm to about 5 mm.

12. The device, according to claim 9, wherein a cross-sectional width of each prop-tube of the plurality of prop-tubes is from about 5 mm to about 25 mm, and wherein a cross-sectional length of each prop-tube of the plurality of prop-tubes is from about 5 mm to about 25 mm.

13. A system for handling and transplanting plants comprising:
a prop-strip comprising a plurality of prop-tubes connected to each other in series along the prop-strip; and
a transplant liner tray having a plurality of cells arranged at intervals that facilitate alignment of the plurality of prop-tubes with said cells, such that the plurality of prop-tubes can be inserted substantially simultaneously into the plurality of cells.

14. The system, according to claim 13, further comprising a rigid backing having a length approximately equal to a length of the prop-strip, wherein the rigid backing is attached to a side of each prop-tube of the plurality of prop-tubes.

15. The system, according to claim 14, wherein the rigid backing has a thickness of about 0.5 mm to about 5 mm.

16. The system, according to claim 13, wherein a cross-sectional width of each prop-tube of the plurality of prop-tubes is from about 5 to about 25 mm, and wherein a cross-sectional length of each prop-tube of the plurality of prop-tubes is about 5 to about 25 mm.

17. A method for handling and transplanting plants comprising:
constructing and arranging a prop-strip with a plurality of prop-tubes; positioning a plant, cutting, tissue-cultured plantlet, or seed within a prop-tube of the plurality of prop-tubes; and
inserting the prop-tube, with the plant, cutting, tissue-cultured plantlet, or seed therein, into a cell of a transplant liner tray.

18. The method, according to claim 17, wherein inserting the prop-tube into the cell of the transplant liner tray comprises:
aligning the plurality of prop-tubes with a plurality of cells in the transplant liner tray; and
inserting the plurality of prop-tubes into the plurality of cells of the transplant liner tray.

19. The method, according to claim 18, further comprising creating a dibble hole in each cell of the plurality of cells of the transplant liner tray before inserting the plurality of prop-tubes into the plurality of cells of the transplant liner tray.

20. The method, according to claim 17, wherein the plurality of prop-tubes is removably connected to the prop-strip, and wherein the method further comprises:
removing the prop-tube, with the plant, cutting, tissue-cultured plantlet, or seed therein, from the prop-strip before inserting the prop-tube, with the plant, cutting, tissue-cultured plantlet, or seed therein, into the cell of the transplant liner tray.
